(19) United States
(12) Patent Application Publication
(10) Pub. No.: US 2006/0238694 A1
(43) Pub. Date: Oct. 26, 2006

(54) Display panel and color filter therein

(75) Inventors: Wan-Jung Chen, Ping Tung City (TW); Hsueh-Ying Huang, Taipei Hsien (TW); Kuo-Hsing Cheng, Taipei (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/359,511

(22) Filed: Feb. 23, 2006

(30) Foreign Application Priority Data
Apr. 22, 2005 (TW) 94112905

(51) Int. Cl. G02F 1/1339

(52) U.S. Cl. 349/156

(57) ABSTRACT

A display panel comprising a first substrate, a second substrate and a plurality of pillar spacers is provided. The first substrate comprises a first base and a black matrix layer with a plurality of openings. The black matrix layer is disposed on the lower surface of the first base. The second substrate is disposed below the first substrate and separated at a predetermined distance from the first substrate. The plurality of pillar spacers for maintaining the predetermined distance. Each of the pillar spacer having a first end and a second end. The first end is inserted into the portion of the plurality of openings, and the second end extends to contact with the second substrate.

### BACKGROUND OF THE INVENTION

(1) Field of the Invention

The present invention relates to a display panel, and more particularly, to a display panel that is composed of a pair of substrates.

(2) Description of the Prior Art

Referring to FIG. 1A. FIG. 1A is a sectional view of a conventional liquid crystal panel 10. The liquid crystal panel 10 comprises a first substrate 11, a second substrate 12, and a liquid crystal layer 13 is disposed between the first substrate 11 and the second substrate 12. The liquid crystal layer 13 comprises a plurality of liquid crystal molecules.

The first substrate 11, generally as a color filter substrate, comprises a first base 111, a color filter layer 112, a black matrix layer 113 and a common electrode layer 119. The color filter layer 112, disposed on the lower surface of the first base 111, comprises an array of red filter units 112R, an array of green filter units 112G and an array of blue filter units 112B, which are arranged evenly and interlacedly. Each of the red filter unit 112R, the green filter unit 112G and the blue filter unit 112B is divided from each other by the black matrix layer 113. The common electrode layer 119 is disposed on a surface of the color filter layer 112 and a surface of the black matrix layer 113, as shown in FIG. 1A, it locating below the color filter layer 112 and the black matrix layer 113.

The second substrate 12, generally as a pixel electrode substrate, comprises a second base 121 and a plurality of pixel electrodes 122. Each of the pixel electrodes 122, respectively locating below each of the red filter unit 112R, each of the green filter units 112G or each of the blue filter units 112R, is disposed on a second base 121. An area corresponding to one pixel electrode 122 and the filter unit (112R-112G or 112B) disposed above it, is generally defined as a sub-pixel area 18.

In a sub-pixel area 18, the pixel electrode 122 and the common electrode 119 cooperate to provide an controllable bias for controlling the rotational angle of liquid crystal molecules, so the transmittance of light coming from a backlight-source 14, which is below the second substrate 12, is able to be modulated. Therefore, each sub-pixels area 18 can present different gray levels. And relying on the color filter layer 112, the liquid crystal panel 10 can provide images with colors.

As mentioned above, the black matrix layer 113 is used for dividing the individual red filter unit 112R, green filter unit 112G and blue filter unit 1 12B. In the displaying point of view, the black matrix layer 113 represents an ineffective displaying area. The black matrix layer 113 is opaque to light and capable of avoiding light leakage from a sub-pixel area 18 to the adjacent sub-pixel area 18. While watching the liquid crystal panel 10 from top of the first substrate 11, an user can see effective displaying areas corresponding to the red filter units 112R, green filter units 112G and blue filter units 1 12B, where are not covered by the black matrix layer 113. As a result, each sub-pixel area 18 is able to precisely show its predetermined color without interference from adjacent sub-pixels.

As shown in FIG. 1A, a plurality of pillar spacers 16, typically disposed below the black matrix layer 113, is used for maintaining a predetermined distance between the first substrate 11 and the second substrate 12. Referring to FIG. 1B. FIG. 1B is a sectional view of another prior liquid crystal panel 10. The disposed positions of the pillar spacers 16 are different from those shown in FIG. 1A. As shown in FIG. 1B, although each of pillar spacers 16 is still disposed below the black matrix layer 1 13, it somehow shifts and is further below the color filter layer 112. The plurality of pillar spacers 16 should be disposed below the black matrix layer 113 is about the display quality concern. In other words, to dispose the pillar spacers 16 in the effective display areas may defeat display quality.

The pillar spacer 16 may be formed from photo resist materials. Therefore, its height (or length) can be controlled precisely. However, the thickness of the black matrix layer 1 13 or the color filter layer 1 12 may not be so uniform because of their fabrication process. As a result, the actually reached position of the bottom end of each pillar spacer 16 may have different distance from the first base 111. As in contacting with the second substrate 12, each pillar spacer 16 may suffer different elastic distortion. Or even worse, some pillar spacer 16 may not be able to contact the second substrate 12, that is, they lost their predetermined function. And the pillar spacer 16 growing from the surface of the black matrix layer 113 or the color filter layer 112 has very limited ability to sustain stress parallel to the first substrate 11. This and other mentioned drawbacks not only influence the product stability, but also have an effect on displaying quality of the effective displaying areas.

Accordingly, improving the above-mentioned drawbacks is the primary issue in the present invention.

### SUMMARY OF THE INVENTION

It is therefore a primary objective of present invention to provide a pillar spacer, which is able of providing a better elastic deformation ability.

It is another objective of present invention to provide a plurality of pillar spacers, which is able to maintain an uniform distance between the first substrate and the second substrate.

It is another objective of present invention to provide a plurality of pillar spacers, which is able to be controlled its height more easily in the manufacturing process.

It is another objective of present invention to provide a pillar spacer, which is able to bear more stresses.

A display panel comprising a first substrate, a second substrate and a plurality of pillar spacers is provided. The first substrate comprises a first base and a black matrix layer with a plurality of openings. The black matrix layer is disposed on the lower surface of the first base. The second substrate is disposed below the first substrate and separated at a predetermined distance form the first substrate. The plurality of pillar spacers is disposed for maintaining the predetermined distance. Each of the pillar spacer having a first end and a second end. The first end is inserted into the portion of the plurality of openings, and the second end extends to contact with the second substrate for maintaining the predetermined distance.

These and other objectives of the present invention will no doubt become obvious to those of ordinary skill in the art after reading the following detailed description of the preferred embodiment which is illustrated in the various figures and drawing.

### BRIEF DESCRIPTION OF THE DRAWINGS

The present invention will now be specified with reference to its preferred embodiment illustrated in the drawings, in which

FIG. 1A is a sectional view of a liquid crystal panel according to a prior art.

FIG. 1B is a sectional view of another prior liquid crystal panel.

FIG. 2A is a sectional view of a display panel according to the first embodiment of the present invention.

FIG. 2B is a sectional view of a display panel according to the second embodiment of the present invention.

FIG. 2C is a sectional view of a display panel according to another present embodiment.

FIG. 3 is a top view of the second substrate shown in FIG. 2A.

FIG. 4 is a top view of a display panel according to one embodiment of the present invention.

FIG. 5 is a top view of a display panel according to one embodiment of the present invention.

FIG. 6 is a top view of a display panel according to one embodiment of the present invention.

FIG. 7 is a top view of a display panel according to one embodiment of the present invention.

FIG. 8 is a top view of a display panel according to one embodiment of the present invention FIG. 9 is a top view of a display panel according to one embodiment of the present invention.

### DESCRIPTION OF THE PREFERRED EMBODIMENT

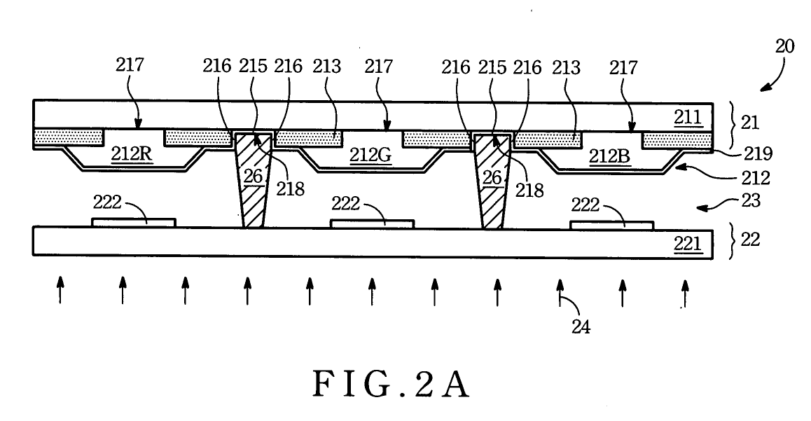

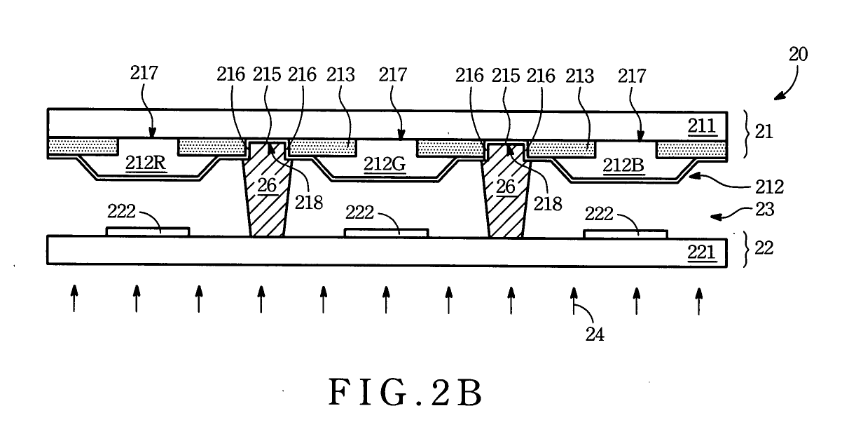

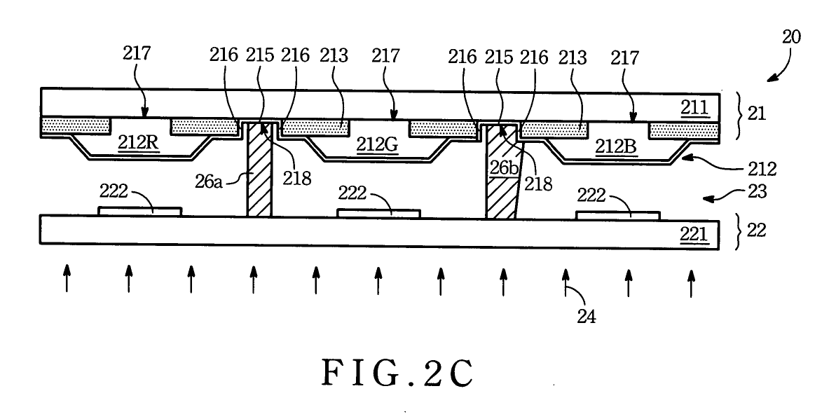

Referring to FIG. 2A. FIG. 2A is a sectional view of a display panel 20 according to the first embodiment of the present invention. The display panel 20 comprises a first substrate 21, a second substrate 22 and a plurality of pillar spacer 26. The first substrate 21 comprises a first base 211, a color filter layer 212 and a black matrix layer 213 with a plurality of openings 218. The second substrate 22 is disposed below the first substrate 21 and is separated at a predetermined distance from the first substrate 21. The plurality of pillar spacer 26 is used for maintaining the predetermined distance. Each pillar spacer 26 has a first end 261 and a second end 262, wherein the first end 261 of each pillar spacer 26 is inserted into the portion of the plurality of openings 218, and the second end 262 of each pillar spacer 26 extends to contact with the second substrate 22. In practice, the plurality of pillar spacer 26 may be made of photo resist materials. A liquid crystal layer 23 fills between the first substrate 21 and the second substrate 22.

In the embodiment shown as FIG. 2A, the first substrate 21 is a color filter substrate. The black matrix layer 213 divides the first substrate 21 into a plurality of transparent areas 217. After the black matrix layer 213 has been formed, a color filter layer 212 is disposed on the lower surface of the first base 211,and at least part of the color filter layer is formed in the plurality of transparent areas.

The color filter layer 212, disposed below the first base 211, comprises an array of red filter units 212R, an array of green filter units 212G and an array of blue filter units 212B, which are arranged evenly and interlacedly.

The first substrate 21 further comprises a common electrode layer 219 covering the color filter layer 212 and a portion of black matrix layer 213. The common electrode layer 219 is made of a transparent and electrically-conductive material, such as indium-tin oxide (ITO), and is for providing an common voltage.

After the common electrode layer 219 has been formed, the plurality of pillar spacer 26 are formed at positions corresponding to the plurality of openings 218. The plurality of pillar spacer 26 may be made of a photo resist material, therefore, in practice, they grow into their predetermined structures from the plurality of openings 218. As a result, the first end 261 of each pillar spacer 26 is inserted into the portion of the plurality of openings 218. And the second end 262 of each pillar spacer 26 can extend to contact with the second substrate for maintaining the predetermined distance from the first substrate 21.

The second substrate 22 is a pixel electrode substrate in this embodiment. The second substrate 22 comprises a second base 221 and a plurality of pixel electrode 222 on the second base 221. Each of the plurality of pixel electrode 222 is respectively disposed below each of the red filter unit 212R, the green filter unit 212G or the blue filter unit 212R. An area corresponding to one pixel electrode 222 and the filter unit (212R-212G or 212B) disposed above-it, is generally defined as a sub-pixel area 28.

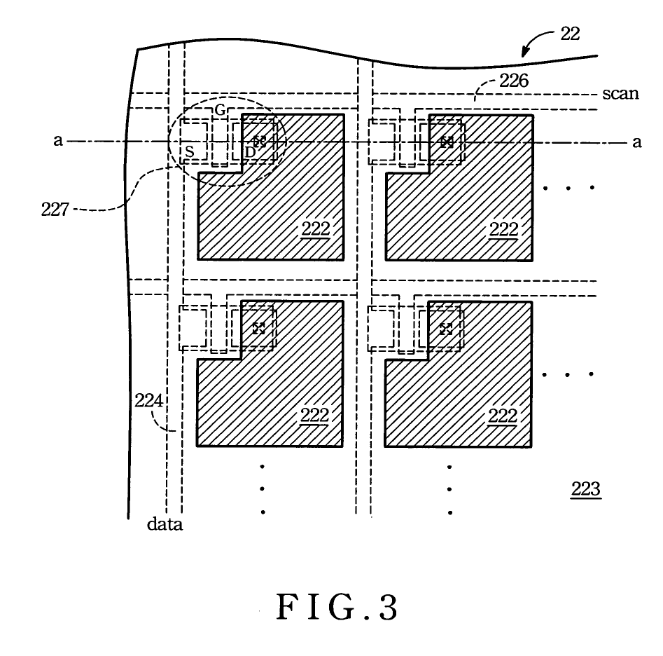

Referring to FIG. 3. FIG. 3 is a top view of the second substrate 22 shown in FIG. 2A. The second base 221 are separated into a plurality of grids by a plurality of data lines 224 and a plurality of scan lines 226. A thin film transistor 227 is disposed on the second base 221 and within an area corresponding to one of the plurality of grids. Gate of each thin film transistor 227 electrically connects to a scan line 226; and source of each thin film transistor 227 electrically connects to a data line 224. The second substrate 22 further comprises a protective layer 223 for covering the plurality of thin film transistor 227, the plurality of data lines 224 and the plurality of scan lines 226. Each of the pixel electrode 222 electrically connects to each drain of a thin film transistor 227 through a through hole (not shown) formed in the protective layer 223. Controlling by signals transmitted from the data lines 224 and the scan lines 226, the pixel electrode 222 is capable of appropriately providing a controllable voltage.

Please returning to FIG. 2A, the common voltage provided by the common electrode layer 219 and the controllable voltage provided by each of the pixel electrode 222, a bias is generated, which is capable of adjusting the rotational angle of liquid crystal molecules of the liquid crystal layer 23, so the transmittance of light coming from a backlight source 24, which is below the second substrate 22, is able to be modulated. Therefore, each sub-pixels area 28 can present different gray levels. And relying on the color filter layer 212, the liquid crystal panel 20 can provide color images.

As shown in FIG. 2A, the plurality of pillar spacer 26 is used for maintaining the predetermined distance between first substrate 21 and the second substrate 22. The predetermined distance ranges from about 2.5 micrometer to about 4.5 micrometer. In the present invention, the plurality of pillar spacer 26 are disposed right below the black matrix layer 213. These filter units (213R, 213B, and 213G ) are respectively divided by the black matrix layer 213. The major function of the black matrix layer 213 is to serve as a masking frame for each sub-pixel area 28 for avoiding light leakage from the adjacent sub-pixel areas 28. Therefore, precise color of each sub-pixel area 28 as its predetermined one is able to be presented.

Referring to FIG. 2A, and further in view of FIG. 3. In a sub-pixel area 28, the effective displaying area, has a shape similar to the shape of the pixel electrode 222. So, preferably, the black matrix layer 213 may be disposed right above the data line 224, the scan line 226 and a portion of the thin film transistor 227 to cover these ineffective displaying areas.

During the fabrication process of the present invention, the plurality of openings 218 is formed in the step of forming the black matrix layer 213. In other words, while forming the pattern of the black matrix layer 213, the plurality of openings 218 and the transparent area 217 both have been formed at the same time.

The first end 261 of the each pillar spacer 26 is inserted into the portion of the plurality of the openings 218. Summarizing several embodiments of the present invention, the depth of the openings 218 ranges from about 0.1 micrometer to about 2.0 micrometer. The depth of the openings 218 is also related to the material of the black matrix layer 213. While the black matrix layer 213 is made of a photoresist material, such as resin, the depth of the openings 218 ranges from about 1 micrometer to about 2 micrometer. However, while the black matrix layer 213 is made of a metal, according to another embodiment, the depth of the openings 218 ranges from about 0.1 micrometer to about 0.2 micrometer.

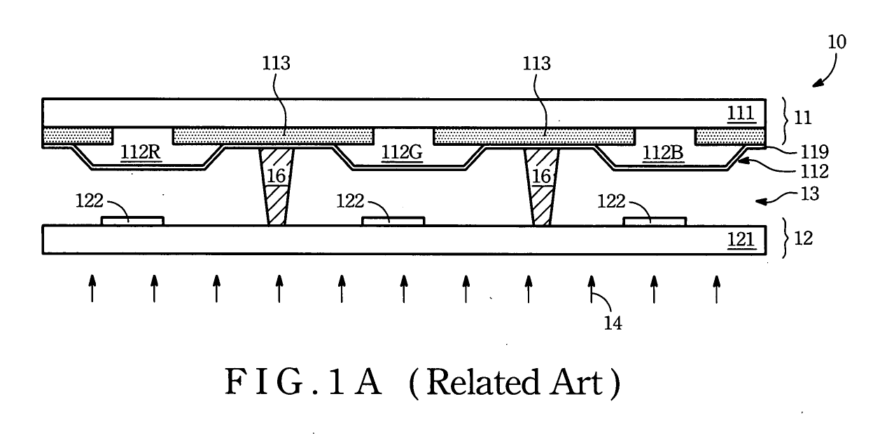

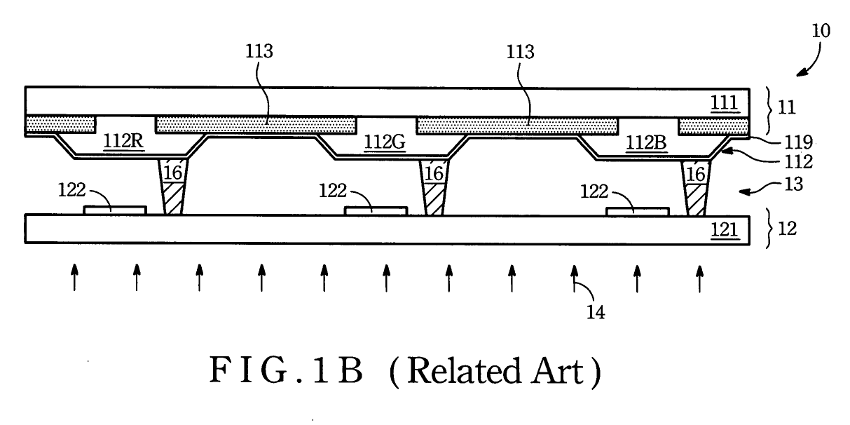

Comparing the present display panel 20 with the prior display panel 10 shown in FIG. 1A. Under a condition of the same predetermined distance between the first substrate(11 or 21) and the second substrate(12 or 22), the length of the present pillar spacer 26 is obviously taller than the length of the prior pillar spacer 16. As a result, the present pillar spacers 26 is able to provide a better elasticity than the prior pillar spacer 16.

Furthermore, the present invention improve the roughness drawback of prior art. As mentioned, the thickness of the prior black matrix layer 113 shown in FIG. 1A or the prior color filter layer 112 shown in FIG. 1 B may be un-uniform. As to the present invention, the first end 261 of each pillar spacer 26 is inserted into the portion of the plurality of openings 218 and is directly contact with the common electrode layer 219. Therefore, each pillar spacer 26 grows from a flat foundation, reached position of the second end 262 of each pillar spacer 26 may have the same distance from the first base 211. As shown in FIG. 2A, the black matrix layer 213 further has at least two sidewall structures 216 in the openings. 218. The pillar spacer 26 is accommodated at least by the two sidewall structures 216. Therefore, the combination of the pillar spacer 26 and the first substrate 21 is relatively more solid than prior arts. The pillar spacer 26 may have ability to sustain relatively larger stress than prior arts, especially the stress parallel to the first substrate 21.

Referring to FIG. 2B. FIG. 2B is a sectional view of a display panel 20 according to the second embodiment of the present invention. Compared with the first embodiment shown in FIG. 2A, the pillar spacer 26 shown in FIG. 2B is not only accommodated by the sidewall structures 216, but a portion of the pillar spacer 26 further stands on the black matrix layer 26. Relatively, the contact-area of this second embodiment is enlarged as compared with the first embodiment shown as FIG. 2A. As a result, combination of the pillar spacer 26 and the first substrate 21 becomes more reliable.

Alternatively, referring to FIG. 2C. It is a sectional view of a display panel 20 according to another present embodiment. The first end 261 of the left pillar spacer 26a of FIG. 2C is inserted into the openings 218. However, the left pillar spacer 26a has a cross section diameter shorter than the bore diameter of the openings 218. In the other hand, the first end 261 of the right pillar spacer 26b is also inserted into the openings 218. Probably resulting from fabrication inaccuracy, the right pillar spacer 26b somehow shifts right. One side of the right pillar spacer 26b further stands on the black matrix layer 213. Although, in practice, the two kind of pillar spacers (26a and 26b) is not so preferable, however, they still fit with the general concept of the present invention and are here disclosed.

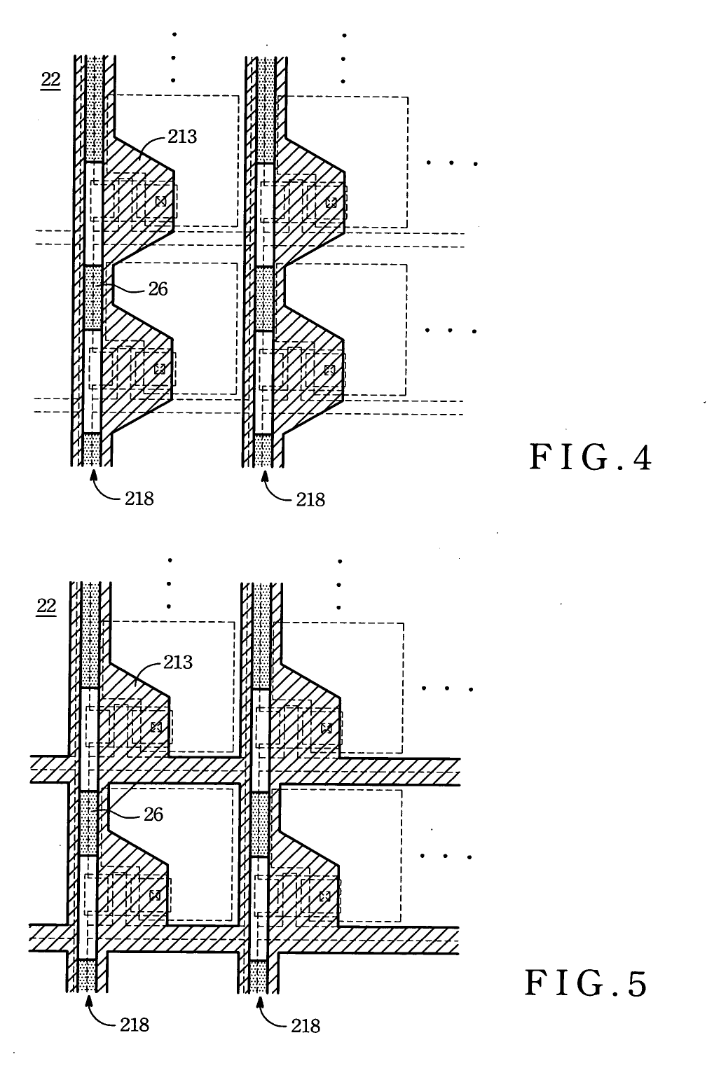

Referring to FIG. 4. FIG. 4 is a top view of a display panel 20 according to one embodiment of the present invention. The black matrix layer 213 is substantially located right above the data line 224 and the thin film transistors 227. In other words, the scan line 226 is not covered by the black matrix layer 227. According to the top view, the opening 218 within the black matrix layer 213 has a shape of a long narrow strip. The position of the openings 218 is located right above the data line 224. In this embodiment, each pillar spacer 26 is accommodated by two sidewall structures 216. Therefore, the amount of contact-faces between each pillar spacer 26 and the first substrate 21 is three.

Referring to FIG. 5. FIG. 5 is a top view of a display panel 20 according to one embodiment of the present invention. The black matrix layer 213 is substantially located right above the data line 224, the scan line 226 and the thin film transistors 227. According to the top view, the opening 218 within the black matrix layer 213 has a shape of a long narrow strip. The position of the opening 218 is located right above the data line 224. In this embodiment, each pillar spacer 26 is accommodated by two sidewall structures 216. Therefore, the amount of contact-faces between each pillar spacer 26 and the first substrate 21 is three.

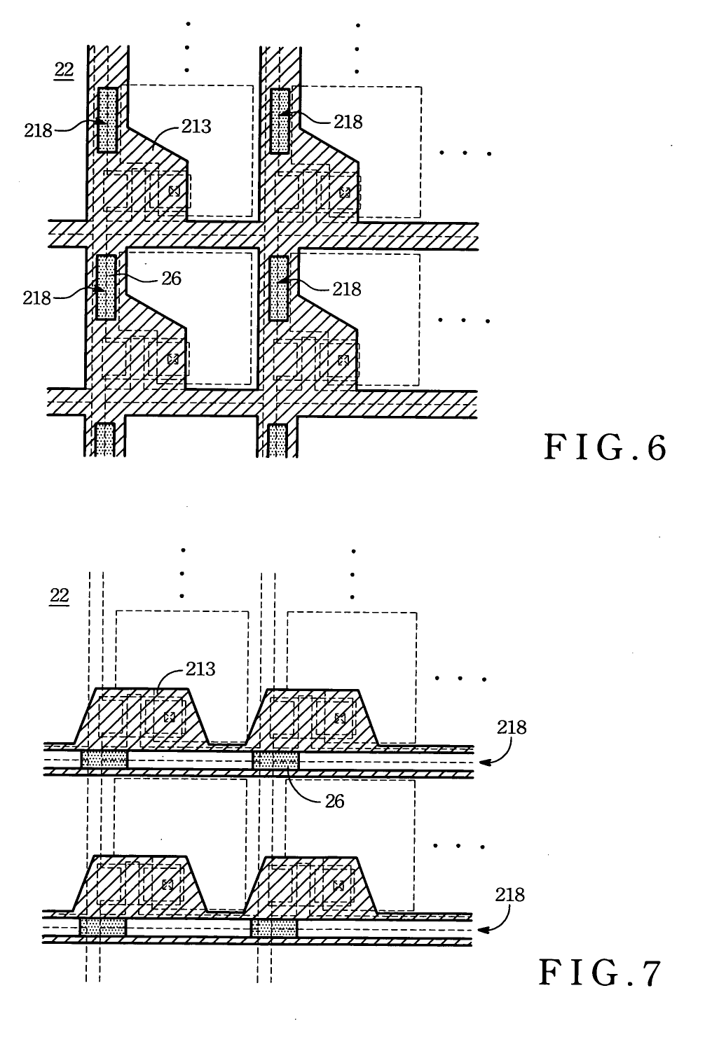

Referring to FIG. 6. FIG. 6 is a top view of a display panel 20 according to one embodiment of the present invention. The black matrix layer 213 is substantially located right above the data line 224, the scan line 226 and the thin film transistors 227. According to the top view, the opening 218 within the black matrix layer 213 has a bar shape. The position of the opening 218 is located right above the data line 224. In this embodiment, each pillar spacer 26 is accommodated by four sidewall structures 216. Therefore, the amount of contact-faces between each pillar spacer 26 and the first substrate 21 is five.

Referring to FIG. 7. FIG. 7 is a top view of a display panel 20 according to one embodiment of the present invention. The black matrix layer 213 is substantially located right above the scan line 226 and the thin film transistors 227. In other word, the data line 224 is not covered by the black matrix layer 213. According to the top view, the opening 218 within the black matrix layer 213 has a shape of long and narrow strip. The position of the opening 218 is located right above the scan line 226. In this embodiment, each pillar spacer 26 is accommodated by two sidewall structures 216. Therefore, the amount of contact-faces between each pillar spacer 26 and the first substrate 21 is three.

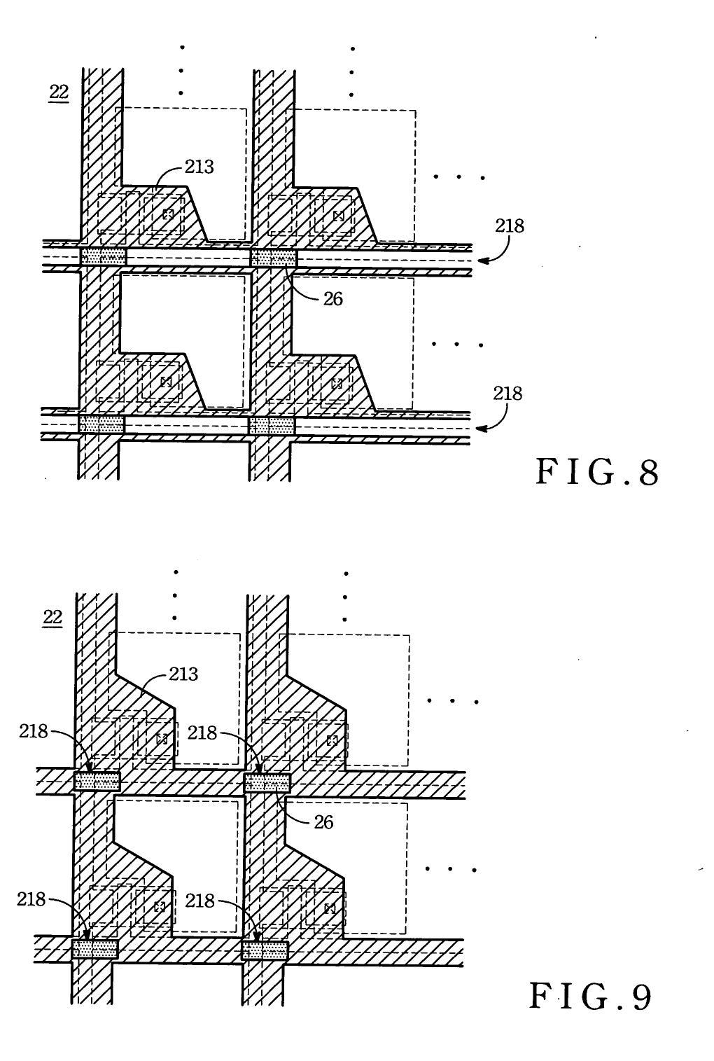

Referring to FIG. 8. FIG. 8 is a top view of a display panel 20 according to one embodiment of the present invention. The black matrix layer 213 is substantially located right above the data line 224, the scan line 226 and the thin film transistors 227. According to the top view, the opening 218 within the black matrix layer 213 has a shape of long and narrow strip. The position of the opening 218 is located right above the scan line 226. In this embodiment, each pillar spacer 26 is accommodated by two sidewall structures 216. Therefore, the amount of contact-faces between each pillar spacer 26 and the first substrate 21 is three.

Referring to FIG. 9. FIG. 9 is a top view of a display panel 20 according to one embodiment of the present invention. The black matrix layer 213 is substantially located right above the data line 224, the scan line 226 and the thin film transistors 227. According to the top view, the opening 218 within the black matrix layer 213 has a bar shape. The position of the opening 218 is located right above the data line 224. In this embodiment, each pillar spacer 26 is accommodated by four sidewall structures 216. Therefore, the amount of contact-faces between each pillar spacer 26 and the first substrate 21 is five.

Accordingly, the present invention has provided a display panel composed of a pair of substrates without drawbacks of prior arts. In the present invention, utilizing the openings formed in the black matrix layer, the present pillar spacers is able to bear more stresses than those of the prior arts, especially for horizontal stresses which is substantially perpendicular to the pair of substrates; Furthermore, each first end of the pillar spacers grows from the common electrode layer, so the drawback of the different reaching position of each second end is improved. Therefore, the predetermined distance between the first substrate and the second substrate is able to be maintained uniformly. And each pillar spacer can contact with the second substrate. As a result, a much more solid product is obtained according to the present invention.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A display panel comprising:
a first substrate, the lower surface of the first substrate having a black matrix layer with a plurality of openings;
a second substrate disposed below the first substrate and separated at a predetermined distance from the first substrate; and
a plurality of pillar spacers for maintaining the predetermined distance, each pillar spacer having a first end and a second end, wherein the first end of each pillar spacer is inserted into the portion of the plurality of openings, and the second end of each pillar spacer extends to contact with the second substrate.

2. The display panel of claim 1, wherein the first substrate is a color filter substrate.

3. The display panel of claim 1, wherein the second substrate is a pixel electrode substrate.

4. The display panel of claim 1, wherein the black matrix layer divides the first substrate into a plurality of transparent areas, the first substrate further comprising at least one color filter layer formed in the plurality of transparent areas.

5. The display panel of claim 4, wherein the first substrate further comprises a common electrode layer covering the color filter layer and the portion of the black matrix layer.

6. The display panel of claim 5, wherein the common electrode layer is disposed between the black matrix layer and the plurality of pillar spacer in the plurality of openings.

7. The display panel of claim 1, wherein the depth of each opening ranges from about 0.1 micrometer to about 2 micrometer.

8. The display panel of claim 1, wherein the predetermined distance ranges from about 2.5 micrometer to about 4.5 micrometer.

9. The display panel of claim 1, wherein the black matrix layer is made from a photoresist material or a metal.

10. The display panel of claim 1, wherein each opening has at least two sidewall structures for accommodating the first end of each pillar spacer.

11. The display panel of claim 10, wherein the size of the at least one of the plurality of openings is substantially equal to that of the first end of the pillar spacer inserted therein.

12. A color filter substrate for use in a display panel, the display panel comprising a pixel electrode substrate disposed below the color filter substrate with a predetermined distance from the color filter substrate, the color filter substrate comprising:
a first base;
a black matrix layer, disposed on the lower surface of the first base, for dividing the first base into a plurality of transparent areas, wherein the black matrix layer having a plurality of openings;
a color filter layer disposed on the lower surface of the first base and at least part of the color filter layer formed in the plurality of transparent areas; and
a plurality of pillar spacers for maintaining the predetermined distance, each pillar spacer having a first end and a second end, wherein the first end of each pillar spacer is inserted into the portion of the plurality of openings, and the second end of each pillar spacer extends to contact with the pixel electrode substrate.

13. The color filter substrate of claim 12, further comprising a common electrode layer covering the color filter layer and the portion of the black matrix layer, wherein the common electrode layer is disposed between the black matrix layer and the plurality of pillar spacers in the plurality of openings.

14. A method for manufacturing a color filter substrate, comprising:
forming a black matrix layer on a first base, wherein the black matrix layer has a plurality of openings and divides the base into a plurality of transparent areas;
disposing a color filter layer in at least part of the transparent areas; and
disposing a plurality of pillar spacers in the openings, each pillar spacer having a first end and a second end, each first end of the pillar spacers being inserted in each of the plurality of openings.

15. The method of claim 14, further comprising:
disposing a common electrode layer for covering the color filter layer and the portion of the black matrix layer.
